(19) United States
(12) Patent Application Publication
(10) Pub. No.: US 2003/0001793 A1
(43) Pub. Date: Jan. 2, 2003

(54) Chip antenna

(75) Inventor: Heung-Soo Park, Kyungki-do (KR)

Correspondence Address: LOWE HAUPTMAN GOPSTEIN GILMAN & BERNER, LLP, Suite 310, 1700 Diagonal Road, Alexandria, VA, 22314, US

(73) Assignee: Samsung Electro-Mechanics Co., Ltd

(21) Appl. No.: 09/985,550

(22) Filed: Nov. 5, 2001

(30) Foreign Application Priority Data
Jul. 2, 2001 (KR) 2001-39336

(51) Int. Cl. H01Q 1/36; H01Q 1/24

(52) U.S. Cl. 343/895; 343/702

(57) ABSTRACT

A chip antenna for use in the blue tooth, in the wireless LAN and in the mobile communication terminal is disclosed. The chip antenna includes the following elements. That is, a base block is made of a dielectric material or a magnetic material, and is parallelepiped. A conductor pattern includes a plurality of side electrodes formed laterally on both side faces of the base block, and a plurality of upper and lower electrodes having bent portions respectively, for being connected to the side electrodes. The side electrodes and the upper and lower electrodes are connected together to form a helical coiling around the base block. A ground terminal is formed on the base block and is connected to a part of the conductor pattern. Thus the antenna can be miniaturized without causing any variation of the antenna characteristics.

### FIELD OF THE INVENTION

The present invention relates to a chip antenna which is used in mobile communication terminals, local area networks (LAN) and the like. More specifically, the present invention relates to a chip antenna in which a vertically bent conductor pattern is formed around a parallelepiped dielectric block so as to make it possible to miniaturize the antenna.

### BACKGROUND OF THE INVENTION

Generally, the known mobile communication apparatus includes: a portable phone body, and a rod shaped antenna, the latter projecting from the top of the portable phone body. The antenna is used for transmitting and receiving the radio waves, and the resonance frequency of the antenna is decided by the total length of the conductor of the antenna.

However, in the antenna for the mobile communication apparatus, the antenna protrudes to the outside, and therefore, the antenna is affected by the ground potential. As a result, the directivity characteristics are varied, and the miniaturization of the mobile communication apparatuses is impeded.

Japanese Patent Application Laid-open No Hei-10-93320 discloses a chip antenna for solving the above described problems.

As shown in FIGs. 1a, 1b and FIG. 2, this chip antenna includes: a base block 1 made of a dielectric material; a conductor 2 formed helically in the interior and on the surface of the base block 1; and a feeding terminal 3 installed on the surface of the base block 1, for supplying a voltage to the conductor 2. The conductor 2 includes a capacitance-forming part 4, and the capacitance-forming part 4 includes a flat part 4b which is disposed in parallel to an open end 4a, so that the antenna characteristics can be maintained at a constant level.

In the above described antenna, however, if the pitch intervals of the helical conductor 2 are reduced to miniaturize the antenna, then the frequency bandwidth is decreased, with the result that the miniaturization of the antenna is impeded.

### SUMMARY OF THE INVENTION

The present invention is intended to overcome the above described disadvantages of the conventional technique.

Therefore it is an object of the present invention to provide a chip antenna in which the antenna can be miniaturized without causing any variation of the antenna characteristics.

It is another object of the present invention to provide a chip antenna in which the median frequency can be lowered as well as increasing the length of the conductor line without causing any reduction of the bandwidth of the antenna.

In achieving the above objects, the chip antenna according to the present invention includes: a parallelepiped base block made of a dielectric or magnetic material;

a conductor pattern including: (a) a plurality of side electrodes formed laterally on both side faces of the base block; and (b) a plurality of upper and lower electrodes having bent portions respectively, for being connected to the side electrodes, the side electrodes and the upper and lower electrodes being connected together to form a helical coiling around the base block; and

a ground terminal formed on the base block and connected to a part of the conductor pattern.

In another aspect of the present invention, the chip antenna according to the present invention includes: a parallelepiped base block formed by stacking a plurality of dielectric or magnetic material sheets;

a conductor pattern including: (a) a plurality of side electrodes formed laterally on both side faces of the base block; and (b) a plurality of upper and lower electrodes having bent portions respectively, for being connected to the side electrodes, the bent parts being lengthwisely directed, and the side electrodes and the upper and lower electrodes being connected together to form a helical coiling within the base block; and

a ground terminal formed on the base block and connected to a part of the conductor pattern.

### BRIEF DESCRIPTION OF THE DRAWINGS

The above objects and other advantages of the present invention will become more apparent by describing in detail the preferred embodiments of the present invention with reference to the attached drawings in which:

FIGs. 1a and 1b are perspective views showing the external appearances of the conventional chip antennas;

FIG. 2 is a perspective view of the conductor pattern of the conventional chip antenna;

FIG. 3 is a perspective view of the chip antenna according to the present invention;

FIG. 4 is a perspective view of the conductor pattern of the chip antenna according to the present invention;

FIG. 5 is a graphical illustration comparatively showing the characteristic curves of the conventional chip antenna and the chip antenna according to the present invention;

FIG. 6 comparatively illustrates the length of the conventional conductor pattern and that of the conductor pattern of the present invention; and

FIG. 7 is a perspective view of another embodiment of the present invention.

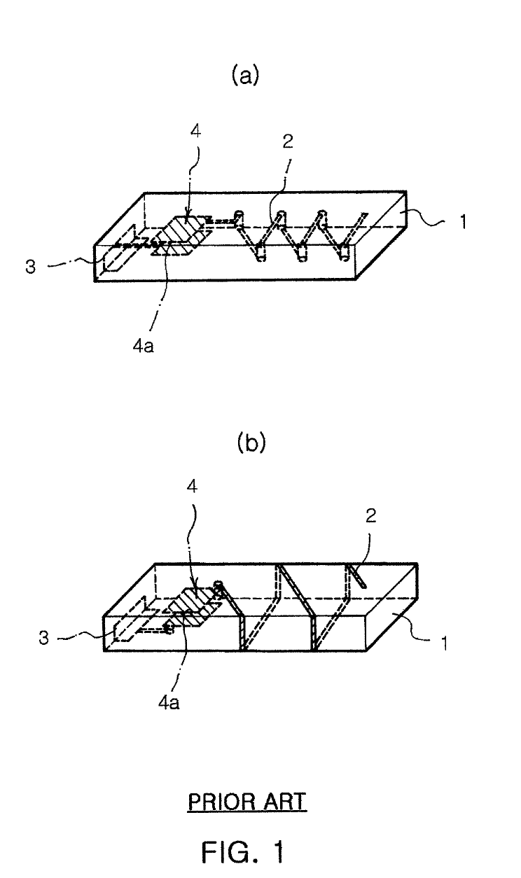

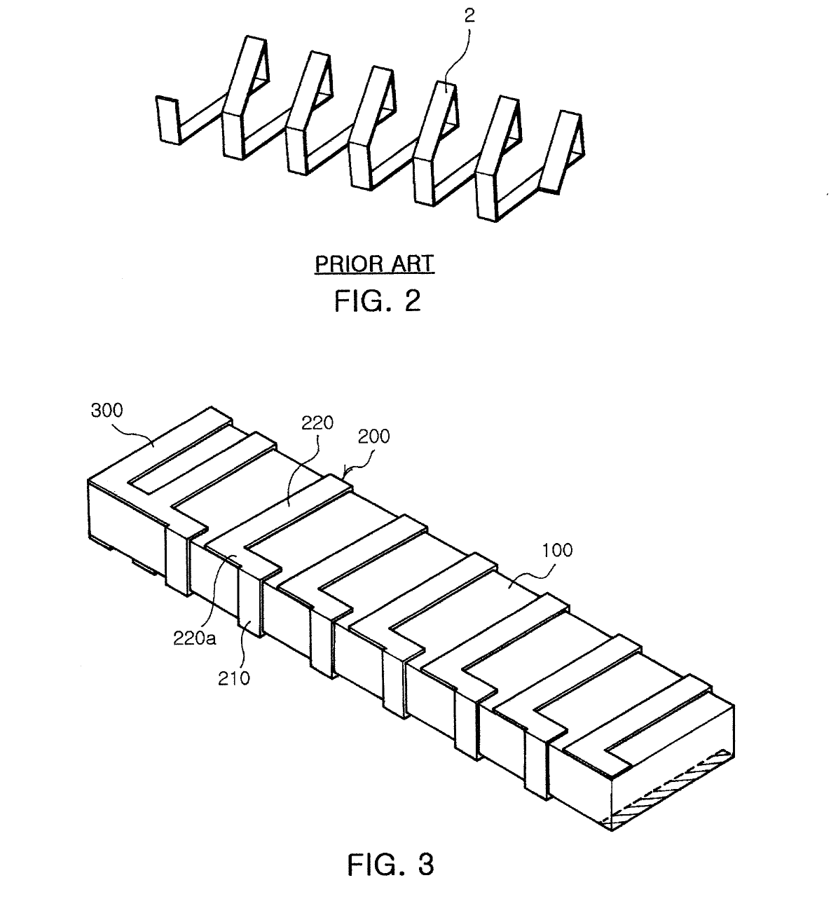

### DETAILED DESCRIPTION OF THE PREFERRED EMBODIMENTS

The present invention will be described in detail referring to the attached drawings.

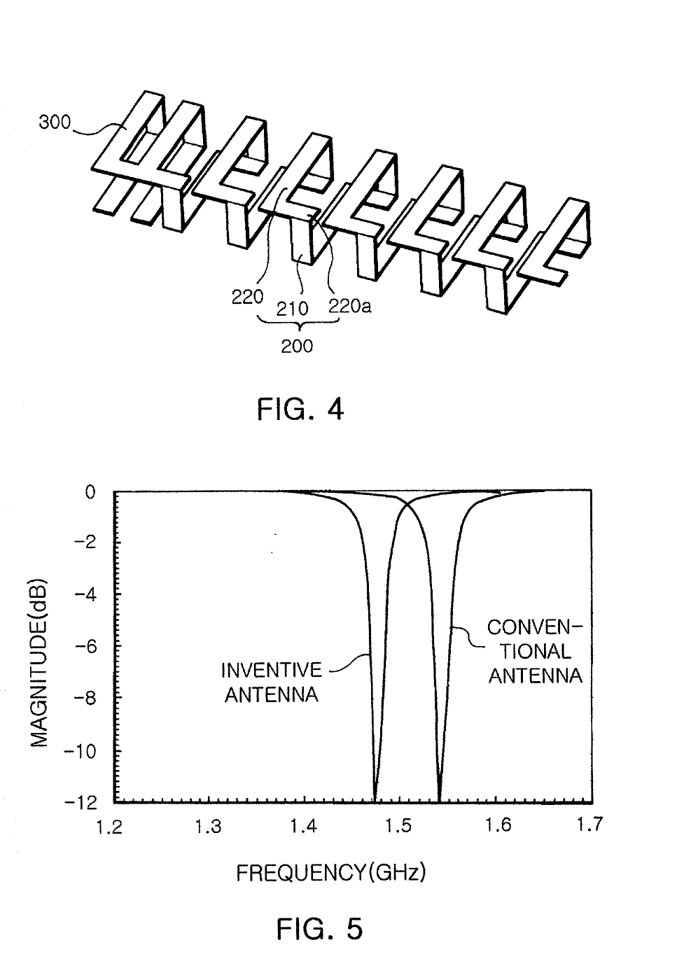

As shown in FIGS. 3 to 6, the chip antenna according to the present invention includes: a base block 100, a conductor pattern 200, and a ground terminal 300.

The base block 100 is made of a dielectric material or a magnetic material, and is parallelepiped.

The conductor pattern 200 which is formed around the base block 100 includes: a plurality of side electrodes 210 laterally formed on both side faces of the base block 100; and a plurality of upper and lower electrodes 220 so as to form a helical coil around the base block 100.

Further, each of the upper and lower electrodes has a substantially rectangularly bent portion 220a.

The ground terminal 300 which is connected to the conductor pattern 200 has a certain size formed on the surface of the base block 100, so that a part of the conductor pattern 200 can be connected to it.

Now the present invention will be described as to its action and effects.

As shown in FIGS. 3 to 6, the base block 100 is made of a dielectric or magnetic material, and is parallelepiped. The plurality of the side electrodes 210, the plurality of the upper and lower electrodes 220 and the plurality of the bent portions 230a form the conductor pattern 200.

The conductor pattern 200 is formed by carrying out a screen-printing or a dipping process so as to form it on the surface of the base block 100. Thus the conductor pattern 200 helically surrounds the base block 100.

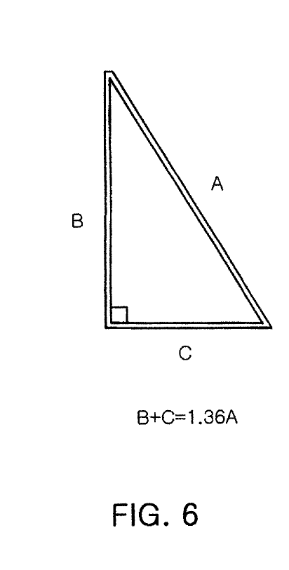

As shown in FIG. 6, owing to the bent portions 230a, the total length of the conductor pattern 200 including the side electrodes 210 and the upper and lower electrodes 220 is extended actually by about 36% compared the conventional one in which the bent portions are missing. As a result, the length of the antenna can be miniaturized.

Further, the ground terminal 300 which is formed on the surface of the base block 100 and which is connected to one end of the conductor pattern 200 can serve as a part of the antenna if it is grounded to a grounding part (not illustrated) of a circuit board or the like.

The ground terminal 300 which is formed on the base block 100 can be easily adjusted as to its area, and therefore, the impedance matching of the antenna can also be easily adjusted.

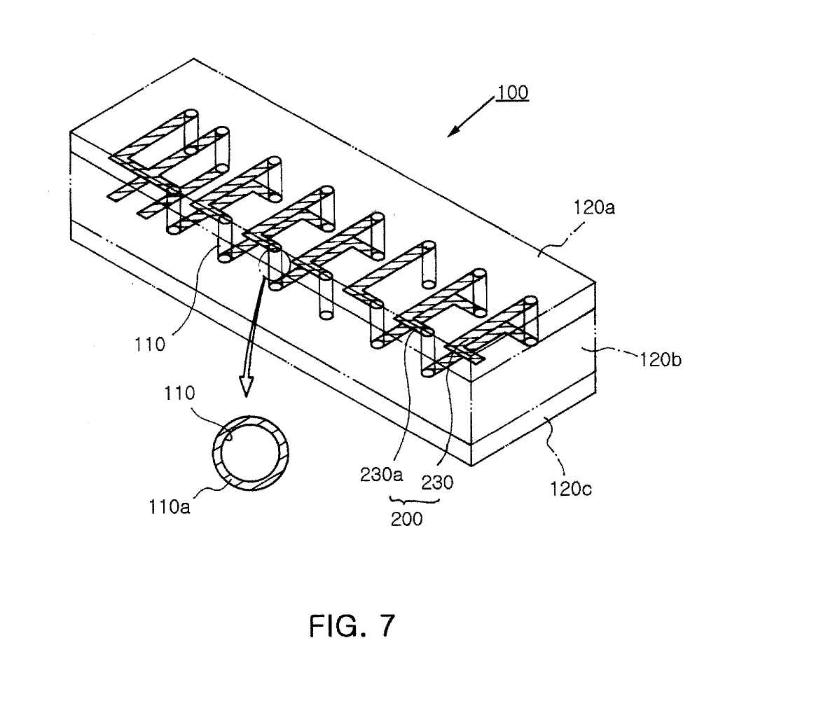

Meanwhile, FIG. 7 illustrates another embodiment of the chip antenna according to the present invention. Here, the base block is formed by stacking a plurality of dielectric or magnetic material sheets 120a, 120b and 120c. In the mentioned sheets, a plurality of via holes 110 are formed, and a conductive film 110a is coated on the inside of each of the via holes 110.

The conductor pattern 200 is disposed within the base block 100 which consists of a plurality of the stacked sheets 120a, 120b and 120c. The via holes 110 are formed vertically within the stacked sheets 120b and 120c, and the bent portions 230a are directed rectangularly to the via holes 110. Thus the internal electrodes 230 are connected through the via holes 110 and the bent portions 230a, thereby forming a helical coiling within the base block 100.

The ground terminal 300 which is connected to the conductor pattern 200 has a certain size formed on the surface of the base block 100, so that a part of the conductor pattern 200 can be connected to it.

Thus the plurality of the sheets 120a, 120b and 120c are stacked to form the base block 100. Under this condition, a plurality of the via holes 110 are formed within the stacked sheets, and a conductive film 110a is formed on the inside of each of the via holes 110. Further, the bent portions 230a and the via holes 110 connect the internal electrodes 230, thereby forming a helical coiling within the base block 100.

The internal electrodes 230 which are connected through the via holes 110 are completely connected through the rectangularly bent portions 230a which are bent substantially by 90 degrees. Therefore, the total length of the conductor pattern is increased by about 36% compared with the conventional conductor pattern. Accordingly, the length of the chip antenna can be miniaturized.

Further, the ground terminal 300 which is connected to the conductor pattern 200 can be arbitrarily adjusted as to its area. Therefore, the impedance matching can be easily adjusted.

According to the present invention as described above, the total length of the conductor pattern can be extended within the fixed volume of the antenna even without the reduction of the bandwidth. Consequently, the antenna can be miniaturized, and the wave reception area is increased with the minimum volume, thereby improving the sensitivity.

In the above, the present invention was described based on the specific preferred embodiments and the attached drawings, but it should be apparent to those ordinarily skilled in the art that various changes and modifications can be added without departing from the spirit and scope of the present invention, which will be defined in the appended claims.

What is claimed is:

1. A chip antenna comprising:
a parallelepiped base block made of a dielectric or magnetic material;
a conductor pattern comprising: (a) a plurality of side electrodes formed laterally on both side faces of the base block; and (b) a plurality of upper and lower electrodes having bent portions respectively, for being connected to the side electrodes, the side electrodes and the upper and lower electrodes being connected together to form a helical coiling around the base block; and
a ground terminal formed on the base block and connected to a part of the conductor pattern.

2. The chip antenna as claimed in claim 1, wherein the side electrodes are vertically formed relative to upper and lower faces of the base block.

3. The chip antenna as claimed in claim 1, wherein the bent portions of the conductor pattern are bent substantially by 90 degrees.

4. The chip antenna as claimed in claim 1, wherein the upper and lower electrodes are L-shaped to be connected to the side electrodes.

5. A chip antenna comprising:
a parallelepiped base block formed by stacking a plurality of dielectric or magnetic material sheets;
a conductor pattern comprising: (a) a plurality of side electrodes formed laterally on both side faces of the base block; and (b) a plurality of upper and lower electrodes having bent portions respectively, for being connected to the side electrodes, the bent portions being lengthwisely directed, and the side electrodes and the upper and lower electrodes being connected together to form a helical coiling within the base block; and
a ground terminal formed on the base block and connected to a part of the conductor pattern.

6. The chip antenna as claimed in claim 5, wherein the side electrodes are vertically formed relative to upper and lower faces of the base block.

7. The chip antenna as claimed in claim 5, wherein the bent portions of the conductor pattern are bent substantially by 90 degrees.

8. The chip antenna as claimed in claim 5, wherein the upper and lower electrodes are L-shaped so as to be connected to the side electrodes.
